(19) United States
(12) Patent Application Publication
(10) Pub. No.: US 2024/0419522 A1
(43) Pub. Date: Dec. 19, 2024

(54) SYSTEM AND METHOD FOR PREDICTING DATA CENTER HARDWARE COMPONENT FAILURE USING MACHINE LEARNING

(71) Applicant: Microsoft Technology Licensing, LLC, Redmond, WA (US)

(72) Inventors: Chin Hwan PARK, Bellevue, WA (US); Lingling ZHENG, Redmond, WA (US)

(21) Appl. No.: 18/335,958

(22) Filed: Jun. 15, 2023

(51) Int. Cl. G06F 11/00; G06F 11/30; G06N 5/022

(52) U.S. Cl. CPC G06F 11/004; G06F 11/3058; G06N 5/022

(57) ABSTRACT

A computerized method for predicting a failure of a component based on environmental conditions is described. Environmental conditions proximate a component in a server are monitored. When the current environmental conditions exceed a threshold level, the current environmental conditions are applied against historical data to predict when the component will fail. Mitigating actions are performed in response to, and prior to, the predicted failure of the component.

### BACKGROUND

Computer operations or services are often conducted from large scale computing facilities, such as data centers. Data centers house a large amount of server, network, and computer equipment to store, manage, process, and distribute large amounts of data used by people and organizations for various purposes. Typically, a computer room of a computing facility includes many server racks. Each server rack, in turn, includes many servers and associated computer equipment. In addition to the computing and networking infrastructure, these data centers are equipped with power and cooling systems to ensure uninterrupted operation and optimal performance.

Data centers play a pivotal role in supporting the digital infrastructure of modern society and enabling the services and applications we rely on every day. When a data center fails, there can be significant consequences for customers depending on the severity of the failure, such as data loss, service disruption, and downtime. To mitigate the impact of data center failures, service providers often implement measures such as redundant systems, backup power supplies, data replication, and disaster recovery plans in an event a data center fails. These strategies aim to minimize downtime, ensure data integrity, and expedite the recovery process in the event of a failure. While these measures are important to have in place, these measures are still reactive measures to a failed data center. As such, it is important to monitor the health and ensure expected performance of a data center's infrastructure and resources.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Example solutions for predicting a failure of a component based on environmental conditions include: receiving an indication that a current environmental condition of an environment proximate to a component in a data center exceeds an environment threshold level; based at least on the indication, determining, using the current environmental condition and historical data of other components exposed to environmental conditions that exceed the environment threshold level, a corrosion rate for the component; based at least on the corrosion rate for the component, determining a time the component will fail; and in response to determining the time the component will fail, performing a mitigation action for the component prior to a failure of the component.

### BRIEF DESCRIPTION OF THE DRAWINGS

The present description will be better understood from the following detailed description read considering the accompanying drawings, wherein:

FIG. 1 is a block diagram illustrating an example system in accordance with some embodiments;

FIG. 2 illustrates a server rack in accordance with some embodiments.

FIG. 3 illustrates a chassis in accordance with some embodiments.

FIG. 4 is a flowchart illustrating an example method for predicting a failure of a component based on environmental conditions;

FIG. 5 illustrates an example computing apparatus as a functional block diagram.

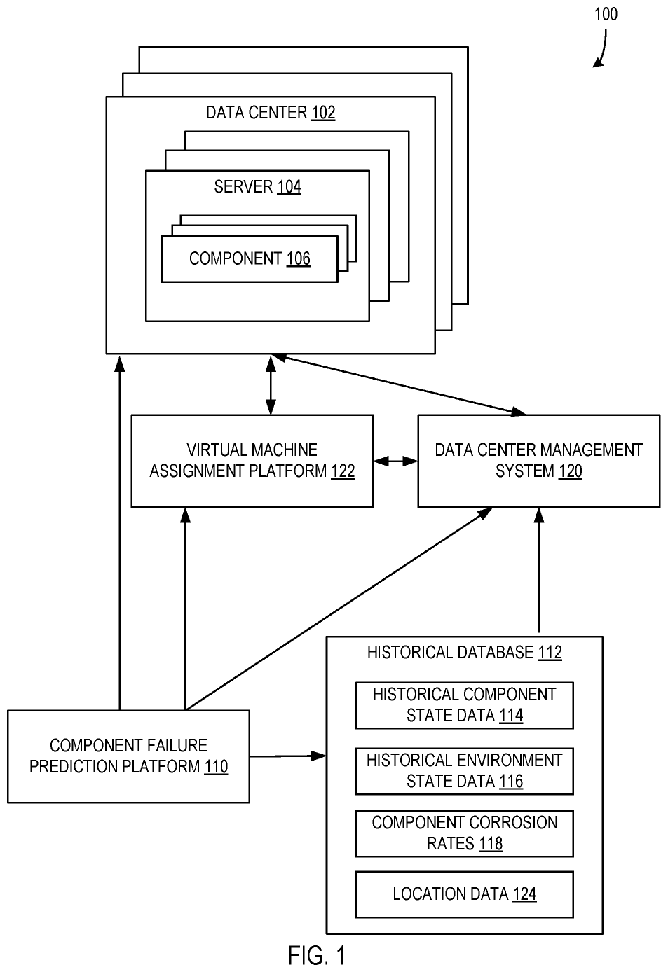

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure provide a system and method for failure prediction precision enhancement of a component based on environmental conditions. The system comprises a plurality of data centers that provide computer implemented services, such as cloud computing services. Therefore, the reliability, performance, and capacity of cloud computing is dependent on the normal operation of an infrastructure of the data centers and a healthy status of the environment, not only within the data centers, but also within chassis within the servers in the data centers.

For example, components within a server may be exposed to environmental conditions, such as increased temperature and humidity, that cause the components to corrode; and therefore, fail unexpectedly. The examples described herein provide systems and methods that reduce the risk of corrosion related failures within a data center by performing a mitigating action prior to a predicted time a particular component is determined to fail. The systems described herein monitor the environmental conditions of an environment external to each server in the data centers, as well as environments internal to each of the servers (e.g., an environment within each chassis of server) to identify environmental conditions (e.g., temperature, humidity, and relative humidity) that place components, such as solid state drives (SSD), at risk of corrosion. Current temperature and humidity levels of an environment proximate a component as well as historical environmental and corrosion data of other components are used as input into a machine learning platform to determine a corrosion rate and predict a time the component will likely fail. Based on the predicted time the component will likely fail, the system determines when to perform mitigating actions in order to minimize or eliminate any disruption in the cloud computing services.

The disclosure operates in an unconventional manner at least by utilizing real time environmental condition data, location data, telemetry data (e.g., performance and health data) and historical data (e.g., logs of other components that have failed previously) to predict when a component will fail. That is, by monitoring temperature, humidity levels, and relative humidity within environments proximate to components of a data center, the systems described herein improve on the ability to predict a possible failure of a component based on environmental conditions. As such, proactive actions can be taken to prevent a negative impact a failed component would have on a server, a datacenter, and ultimately the cloud computing services offered thereon.

In addition to preventing a negative impact a failed component would have on the system, utilizing the real time monitoring of environmental conditions, the system can perform actions that can reduce or mitigate corrosion of components based on undesired environmental conditions (e.g., a temperature and a relative humidity that produces condensation on the components). That is, once the system identifies an environmental condition that is above a desired environmental threshold, the system can initiate measures, such as providing a particular airflow proximate a component to bring the environmental conditions proximate the component from above the desired environmental threshold to below the desired environmental threshold, enabling the component to remain functioning as planned with little to no risk of corrosion, and thus little to no risk of a failure due to corrosion. Thus, these counter measures decrease the temperature and/or decrease a humidity level/relative humidity of the environment proximate the component, which reduces the rate of corrosion or decreases a possibility of corrosion.

Accordingly, the system addresses an inherently technical problem of accurately and efficiently predicting component failure due to environmental conditions and provides a technical solution by pro-actively taking action to either reduce or eliminate a failure due to environmental conditions or pro-actively taking action prior to a time a component is predicted to fail, such as migrating virtual machines executed on one component (e.g., the component predicted to fail) to another, healthy component. As such, the systems described herein are less likely to prematurely fail, have an extended life expectancy, have an improved infrastructure, are less costly to operate, and provide better/consistent/uninterrupted services to users.

FIG. 1 is a block diagram illustrating an example system 100 configured for monitoring and predicting a failure of components within data centers 102 based on a location and environmental conditions to accurately and efficiently improve data center reliability. The system 100 includes a plurality of data centers 102, with each of the plurality of data centers 102 comprising a plurality of servers 104 (e.g., hundreds of the servers 104). Each of the servers 104 comprise components 106, such as SSDs, that are capable of hosting one or more virtual machines.

A component failure prediction platform 110 (which may be associated with, for example, offline or online learning) accesses a historical database 112. The historical database 112 comprises historical component state data 114, historical environment state data 116, component corrosion rates 118, and location data 124. In one example, the historical component state data 114 comprises a metric that represents a health status or an attribute of the components 106 in the data centers 102 during a period of time prior to a component failure. In some examples, the metric represents a health status or an telemetry attribute of a node (e.g., indicating healthy operation or a failure along with a particular mode of failure) during a period of time prior to a component failure. That is, while the examples described herein enable environmental conditions to be a factor when determining when a component will fail (or is likely to fail), environmental conditions can be used on their own, or along with telemetry data. Some examples of telemetry data that can be used to predict component failure for an SD are, “SMART” attributes (e.g., self-monitoring, analysis and reporting technology), a monitoring firmware which allows a disk drive to report data about its internal activity, physical disk performance, storage events, and physical disk events. For other components like memory, SEL and WHEA log data which has indication of error events are also collected and used.

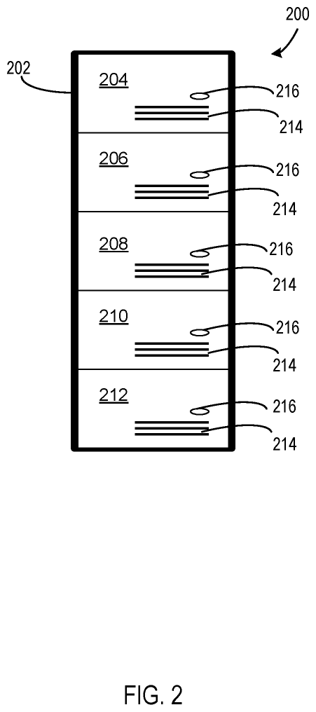

In one example, the attribute corresponds to an operation of a component, such as a number of disk write re-tries that were performed over a period of time by a particular component before the component experienced a failure. In some examples, the location data 124 includes location information for datacenters, location information for servers within a datacenter, and location information for components of the servers. In some embodiments, information in the historical database 112 comes from a variety of sources/monitoring tools that track the health and operation at the system 100 level, at the data center 102 level, at the server 104 level, at a chassis level (e.g., chassis 204-214 shown in FIG. 2), and even at the component 106 level. For example, information may be sent from a data center management system 120 that manages and monitors the health of the data centers 102 or information may come directly from a signal emitted by the components 106. In this way, the system 100 maintains current data of a dynamic cloud computing environment.

The component failure prediction platform 110 includes a machine learning model that uses data, such as the historical component state data 114, the historical environment state data 116, the component corrosion rates 118, and the location data 124 to generate a trained component failure prediction algorithm that predicts when one or more of the components 106 may fail due to environmental conditions, such as temperature, humidity level, and relative humidity. As used herein, the phrase “machine learning” refers to any approach that uses statistical techniques to give computer systems an ability to learn (i.e., progressively improve performance of a specific task) with data without being explicitly programmed. Examples of machine learning may include decision tree learning, association rule learning, artificial neural networks deep learning, inductive logic programming, Support Vector Machines (“SVM”), clustering, Bayesian networks, reinforcement learning, representation learning, similarity and metric learning, sparse dictionary learning, genetic algorithms, rule-based machine learning, learning classifier systems, etc.

In some examples, the historical environment state data 116 includes historic temperature, humidity levels, and relative humidity proximate the components 106 in the data centers 102. In some examples, the component corrosion rates 118 include a rate of corrosion of the components 106 during the period of time prior to a component failure. The corrosion rates are based at least on environment data, such as temperature, humidity level, and relative humidity, with respect to the components 106.

While knowing when a component will fail based on environmental conditions or that the component has an increased possibility of failing based on environmental conditions enables the data center management system 120 to take proactive actions to prevent a negative impact a failed component would have on a server, a datacenter, and ultimately the cloud computing services offered thereon, a virtual machine assignment platform 122 provides the ability to track which virtual machines would be impacted by a particular component failing. That is, in some examples the virtual machine assignment platform 122 assigns virtual machines to be executed on a particular one of the components 106 and/or monitors which virtual machines are assigned to the particular components 106.

Accordingly, the data center management system 120 and the virtual machine assignment platform 122 have knowledge of which virtual machines are assigned to which of the components 106, as well as the locations (e.g., physical locations) of the components 106, the servers 104, and the data centers 102. As such, when a live migration is implemented as a result of a mitigating action being executing in light of a predicted failure of one of the components 106, the virtual machine assignment platform 122 has knowledge of which of the components 106, on which of the servers 104, in which of the data centers 102 are healthy and have a capacity for the virtual machines being migrated from the component that is predicted to fail. The virtual machine assignment platform 122 may store information into and/or retrieve information from various data sources, such as the data center management system 120 (e.g., containing configuration and/or operational details about an availability of the components 106). Although a single virtual machine assignment platform 122 is shown in FIG. 1, any number of such devices may be included. Moreover, various devices described herein might be combined according to embodiments of the present disclosure. For example, in some embodiments, the component failure prediction platform 110 and the virtual machine assignment platform 122 might comprise a single apparatus. The component failure prediction platform 110 and/or the virtual machine assignment platform 122 functions may be performed by a constellation of networked apparatuses in a distributed processing or cloud-based architecture.

As used herein, devices and components, including those associated with the system 100 and any other device or component described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

A user may access the system 100 via remote monitoring devices (e.g., a Personal Computer (“PC”), tablet, smartphone, or remotely through a remote gateway connection to view information about and/or manage data center operation in accordance with any of the embodiments described herein. In some cases, an interactive graphical display interface may let a user define and/or adjust certain parameters (e.g., virtual machine assignments and temperature/humidity thresholds) and/or provide or receive automatically generated recommendations or results from the component failure prediction platform 110 and/or virtual machine assignment platform 122.

In this way, a cloud infrastructure may utilize a trained component failure prediction algorithm to intelligently allocate virtual machines on healthy ones of the components 106 and healthy ones of the servers 104, so that the cloud computing services provided by the data centers 102 are not disrupted and the virtual machines are less likely to suffer future failures due to environmental conditions of their host (e.g., the components 106). In addition to migrating the virtual machines, the trained component failure prediction algorithm may be utilized to either fix or replace ones of the components 106 that are predicted to fail.

The component failure prediction platform 110 may use historical component failures records (from, for example, the historical database 112) as labels, and train the machine learning model to predict whether a component is likely to suffer failures based on factors, such as, exposure to high temperatures (e.g., temperatures above an accepted threshold), exposure to high humidity levels (e.g., humidity levels above an accepted threshold), a length of time the component was exposed to the high temperatures and/or high humidity levels, and how many times and/or how frequent the component was exposed to the high temperatures and/or high humidity levels.

In some examples, there may be technical challenges when designing an appropriate machine learning model at a substantially large scale. For example, the components 106 failing based on environmental conditions might be a very small sample when compared to failures/faults that are a result of other factors (e.g., factors that are not a result of the environment). In some examples, this can make training and evaluating a model difficult. For example, a model/algorithm that always returns “healthy” might be correct 99.9% of the time. Thus, it can be a challenge to effectively train a model with such imbalanced samples. To address this issue, some examples described herein, instead of predicting whether a component will fail based on environmental conditions, the machine learning model generates a likelihood that a component is likely to fail based on the environmental conditions. Further, it can be challenging to identify underlying reasons for a failed component. To address this issue, some examples utilize a feedback loop to actively select components for stress testing or visual inspection in order to obtain the underlying truth. The underlying truth can then be fed into a next iteration of learning.

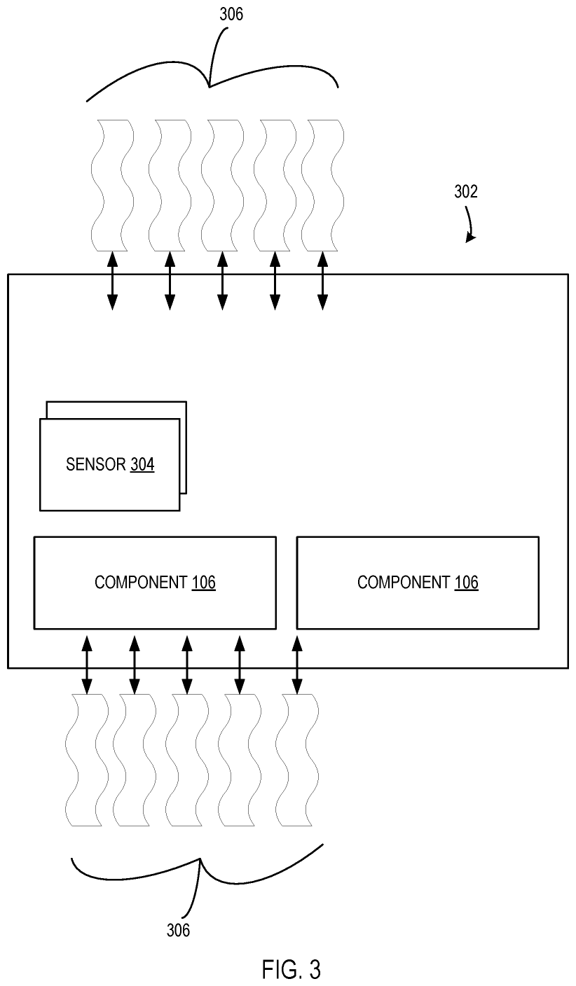

With reference now to FIG. 2, an exemplary server rack for a server 200 (e.g., one of the servers 104) is provided. As shown in FIG. 2, the server 200 includes a frame 202 and a number of chassis (e.g., chassis 204-212). The frame 202 includes a structure that enables the chassis 204-212 to be positioned with respect to one another, such as a rack mount enclosure that enables the chassis 204-212 to be disposed within it. The server 200 may be implemented as other types of structures adapted to house, position, orient, and/or otherwise physically, mechanically, electrically, and/or thermally manage various chassis. While the server 200 enables multiple chassis to be densely packed in space without negatively impacting the operation of the server 200, each of the chassis 204-212, which include the components 106, has their own unique environmental conditions based on where the chassis is placed in the server 200, where vents/air flow are located within the server 200, and where the server 200 is placed with the data center 102. As such, to monitor environmental conditions for each of the components 106, sensors (e.g., sensors 304 shown in FIG. 3) are placed proximate to each of the components 106 within a chassis. In some examples, sensors 216 are also placed on an exterior of each of the chassis 204-212, on various parts of the server 200 (not shown), and in various locations throughout the data center 102 (not shown). Each of these sensors (e.g., the sensors 216) are capable of measuring, in real time, one or more of the following, a temperature, humidity levels, and relative humidity.

It will be understood that any number of the components 106 may be disposed in each of the chassis 204-212. The preferred temperature ranges within the chases 204-212 and external to the chassis 204-212 may include a nominal range in which the components 106 respectively operate without detriment and/or are likely to be able to continue to operate through a predetermined service life of the components 106. As such, it is not only desirable to maintain the temperatures of the respective components 106 within the preferred range (e.g., a nominal range), but also maintain the temperature of the environment external to the chassis 204-212. However, when the components 106 operate in temperatures outside of the preferred range, a service life of the components 106 may be reduced, the components 106 may not be able to perform optimally, and/or the components 106 may be more likely to unexpectedly fail.

To operate the components 106 within the preferred range of temperature, the chassis 204-212 may include air exchanges 214, such as one or more openings in an exterior of the chassis 204-212 that enables the chassis 204-212 to exchange air with an ambient environment. By doing so, the temperature of the air within the chassis 204-212 may be reduced when cooler air is taken into the chassis 204-212 via the air exchanges 214. However, when the temperature of the air taken into the chassis 204-212 via the air exchange 214 is above a desired environmental threshold level, the air within the chassis 204-212 may be increased. Further, the air provided through the air exchanges 214 may include humidity or dust, and thus interact with the components 106 disposed within the chassis 204-212 in an undesirable manner. For example, when the air being exposed to the components 106 includes humidity, the humidity may condense resulting in water being disposed on surface of the components 106 within the chassis 204-212. When water is disposed on the surface of the components 106, such as SSD's, the water may chemically react with the components 106 forming corrosion, which not only damages the components 106, but also impacts the functionality of the components 106 (e.g., the virtual machines executed thereon), the server 200 and therefore the cloud computer services provided by the data centers 102. For example, the corrosion may impact the conductivity of the metals of the components 106. The reduced conductivities of the components 106 can negatively impact the electrical functionality of the components 106 (e.g., circuits) disposed within the chassis 204-212. Further, the corrosion can increase a size of the components 106 based on the products formed by the reactions. The change in volumes of the reacted metals may negatively impact the electrical functionality of the components 106 by, for example, forming open circuits by physically disconnecting various portions of the components. The examples described herein also contemplate other negative impacts corrosion may cause outside of what is described herein.

To address the negative impact the temperature and humidity may have on the components 106, the environmental conditions within chassis 204-212, within the servers 104, and within the data centers 102 are monitored (e.g., using sensors, such as the sensors 216) to identify when the environmental conditions (e.g., temperature and humidity) exceed a desired environmental threshold level and to predict, based on the environmental conditions exceeding the desired environmental threshold level, when a component (e.g., one of the components 106) will fail or is likely to fail.

Turning to FIG. 3, a block diagram of an exemplary chassis 302 (e.g., one of the chassis 204-212 shown in FIG. 2) is provided. To provide the computing services, the server 104 utilizes computing resources provided by the components 106 housed within the chassis 302. In some examples, the components 106 are SSD's; however, one or more of the components 106 may be processors, memory modules, storage devices, special purpose hardware, and/or other types of physical components that contribute to the operation of the server 104.

To maintain the temperatures of the environment within the chassis 302, as well as the temperature of the components 106, to be below a threshold temperature, air is taken in through an air exchange 306 and passed by the components 106 to exchange heat with them. However, by intaking and expelling air used for cooling purposes, the components 106 disposed within the chassis 302 may be exposed to unfavorable environmental conditions. For example, as discussed above, the air exterior to the chassis 302 may include humidity levels that cause chemical reactions (such as corrosion) to occur on the components 106. The corrosion can damage the structure and/or change the electrical properties of the components 106, which can negatively impact the ability of the component 106 and the server 104 to provide the intended functionality. Thus, due to an exposure to a temperature that exceeds a temperature threshold level and a humidity level that exceeds a humidity threshold level (e.g., creating a relative humidity that is above a desired environmental threshold level), corrosion may occur on the component 106 as a result and the component 106 is likely to fail before the expected service life of the component 106.

As explained above, to monitor the environment conditions within the chassis 302, the chassis 302 includes one or more sensors 304 that send real time data (e.g., real time temperature, humidity levels, and/or relative humidity) to, for example, the data center management system 120. In some example, a single one of the sensors 304 measures/provides one or more of the following: a temperature, a humidity level, and a relative humidity. In other examples, each of the temperature, the humidity level, and the relative humidity are measured/provided by separate/dedicated ones of the sensors 304. The sensors 304 enable the relative humidity level and temperature within the chassis 302 to be determined. In some examples, the functionality of the sensors 304 (e.g., temperature and humidity sensors) are provided by the components 106. For example, the components 106 may include functionality to report their respective temperatures and/or temperatures of the environment within the chassis 302.

In some examples, the chassis 302 includes its own management system that obtains/monitors the environmental conditions within the chassis 302 as well as locations of the components 106 and the sensors 304 within the chassis. For example, a computing device (not shown) disposed in the chassis 302 may host a program that provides the functionality of the data center management system 120. In this example, the chassis 302 own management system communicates with the data center management system 120 and/or the component failure prediction platform 110 with data relating to not only the environmental conditions within the chassis, but also the health and telemetry data of the components 106 within the chassis 302. The information obtained by the data center management system 120 (or the chassis 302 own management system) using various ones of the sensors 304 includes the temperature of the components 106, airflows disposed within the chassis 302, humidity levels within the chassis 302, and/or the relative humidity within the chassis 302. Utilizing this information, the health and telemetry data of the components 106, the information within the historical database 112, the component failure prediction platform 110 determines estimates regarding a corrosion rate occurring on the components 106.

In some examples, to determine corrosion rates, the component failure prediction platform 110 accesses the component corrosion rates 118 within the historical database 112 to calculate the likely corrosion rates of the components 106 based on the information within the historical database 112. For example, the component corrosion rates 118 may include tables that specify, as a function of temperature and relative humidity, a rate of corrosion occurring with respect to various ones of the components 106 disposed within various chassis. To determine whether a component will fail, and more specifically, predict a timing of when the component will fail due to corrosion, the component failure prediction platform 110 determines a total amount of corrosion that has likely occurred already and estimates the rate that corrosion will continue to occur in the future based on the current environmental conditions. In some examples, the component failure prediction platform 110 uses the historical component state data 114, the historical environment state date 116, the component corrosion rates 118, and the location data along with the previous amount of corrosion and the current rate of corrosion for particular component to predict when the component will fail or is likely to fail. For example, based on the information within the historical database 112, the component failure prediction platform 110 can determine a total amount of corrosion that will cause the components 106 to fail. As such, a current corrosion rate of a component along with the previous amount of corrosion that has already occurred on the component (if any) is compared with the amount of corrosion that has historically caused a component to fail (e.g., as determined from the information within the historical database 112) to help predict the failure of the component due to corrosion. In some examples, information within the historical database 112 includes component model numbers, component locations within a chassis, component locations within a server, server locations within a data center, air flows within a chassis, air flows within a server, and air flows within a data center. This information is used by the component failure prediction platform 110 to better predict component failure due to environmental conditions.

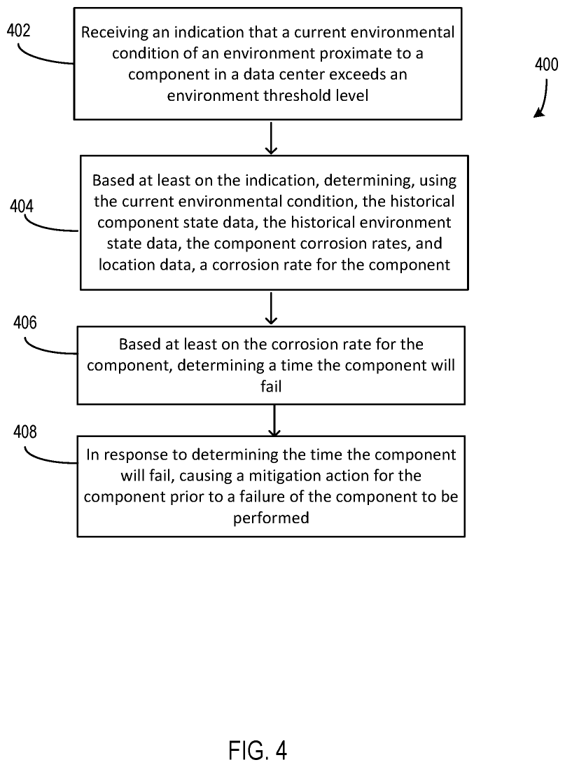

FIG. 4 is a flowchart illustrating an exemplary method 400 for predicting a failure of a component based on environmental conditions. In some examples, the method 400 is executed or otherwise performed by or in association with a system such as system 100 of FIG. 1.

At 402, an indication that a current environmental condition of an environment proximate to a component (e.g., one of the components 106) exceeds a desired environmental threshold level is received by, for example, the component failure prediction platform 110. In some examples, the environmental condition is one or more of the following: a temperature, a humidity, and a relative humidity. In one example, the indication is determined by the component failure prediction platform 110 based at least on a continuous monitoring of the environmental conditions by the component failure prediction platform 110. In another example, the component failure prediction platform 110 is notified by the data center management system 120 or by one of the components 106 or sensors (e.g., the sensor 304) within a chassis that includes the respective component, once an environmental condition exceeds the desired environmental threshold level. At 404, based at least on the indication, the component failure prediction platform 110 uses the current environmental condition, the historical component state data 114, the historical environment state data 116, the component corrosion rates 118, and the location data 124 to determine a corrosion rate for the component 106. In one example, the component failure prediction platform generates or utilizes a machine learning failure prediction algorithm to determine the time the component 106 will fail. At 406, based at least on the corrosion rate for the component 106, the component failure prediction platform 110 determines a time the component will fail. In some examples, in addition to utilizing the current environmental condition, the historical component state data 114, the historical environment state data 116, the component corrosion rates 118, and the location data 124, the component prediction platform 110 also utilizes a current health of a component based at least on telemetry data/log analysis data to determine a time the component will fail. That is, different components experience a loss of performance (or varying degrees of loss of performance) based on different amounts of exposure the component has had with respect to environmental conditions exceeding a threshold. Further, these components experience a loss of performance (or varying degrees of loss of performance) based on different amounts of corrosion and/or where the corrosion is taking place. As such, in some examples, the current health of the component is utilized along with a corrosion rate to determine a time (or if) the component will fail.

At 408, in response to determining the time the component 106 will fail, the component failure prediction platform 110 causes a mitigation action for the component 106 to be performed prior to the component failing. In one example, the component failure prediction platform 110 causes the mitigation action by providing the data center management system 120 of the predicted time the component 106 will fail. In some examples, the mitigation action comprises one or more of the following: migrating virtual machines hosted on the component to another component that has a risk of failure below a risk threshold, replacing the component with a healthy component, or reallocating or reconfiguring a healthy component near the component, and/or applying a particular airflow approximate the component to reduce the temperature level and the humidity level below the threshold level.

### Exemplary Operating Environment

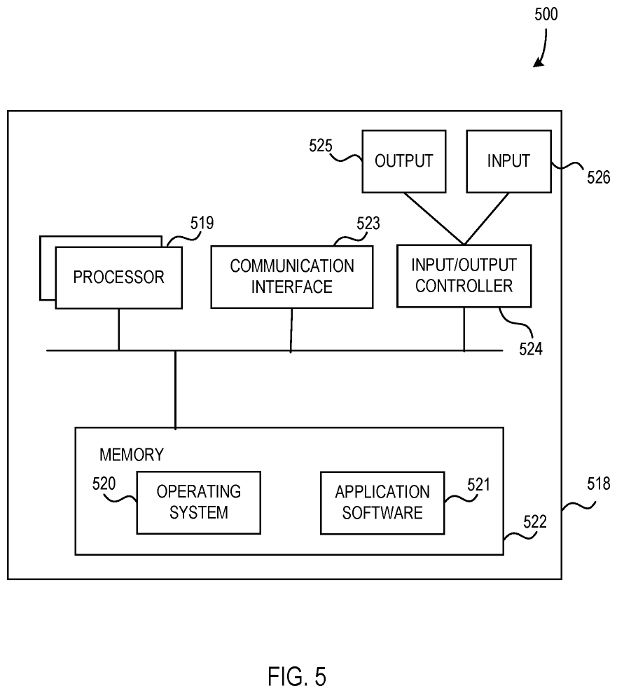

The present disclosure is operable with a computing apparatus according to an embodiment as a functional block diagram 500 in FIG. 5. In an example, components of a computing apparatus 518 are implemented as a part of an electronic device (e.g., an electronic device that either includes or is connected to the data center management system 120) according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Propagated signals per se are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a data center management system, the data center management system comprising a processor; a data center sensor; a historical database comprising historical component state data, historical environment state data, and component corrosion rates, the historical component state data comprising a metric that represents a health status or an attribute of components in data centers during a period of time prior to a component failure, the historical environment state data comprising a temperature and a humidity proximate the components in the data centers during the period of time prior to the component failure, the component corrosion rates providing a rate of corrosion of the components during the period of time prior to the component failure based at least on the environment data with respect to the component; a computer-readable medium comprising computer-executing instructions that, when executed by the processor, cause the processor to perform the following operations: receiving, from the data center sensor, an indication that a current environmental condition of an environment proximate to a component in a data center exceeds an environment threshold level; based at least on the indication, determining, using the current environmental condition, the historical component state data, the historical environment state data, and the component corrosion rates, a corrosion rate for the component; based at least on the corrosion rate for the component, determining a time the component will fail; and in response to determining the time the component will fail, performing a mitigation action for the component prior to a failure of the component.

An example computerized method comprises: receiving an indication that a current environmental condition of an environment proximate to a component in a data center exceeds an environment threshold level; based at least on the indication, determining, using the current environmental condition and historical data of other components exposed to environmental conditions that exceed the threshold level, a corrosion rate for the component; based at least on the corrosion rate for the component, determining a time the component will fail; and in response to determining the time the component will fail, performing a mitigation action for the component prior to a failure of the component.

One or more computer storage media having computer-executable instructions that, upon execution by a processor, cause the processor to perform the following: receive an indication that a current environmental condition of an environment proximate to a component in a data center exceeds an environment threshold level; based at least on the indication, determine, using the current environmental condition and historical data of other components exposed to environmental conditions that exceed the threshold level, a corrosion rate for the component; based at least on the corrosion rate for the component, determine a time the component will fail; and in response to determining the time the component will fail, perform a mitigation action for the component prior to a failure of the component.

Alternatively, or in addition to the other examples described herein, examples include any combination of the following:
wherein the environmental condition comprises a temperature level and a humidity level.
wherein the component is a solid state drive.
further comprising a component failure prediction platform coupled to the historical database, the component failure prediction platform generating a machine learning failure prediction algorithm that determines the time the component will fail.
wherein the mitigating action comprises migrating virtual machines hosted on the component to another component that has a risk of failure below a risk threshold.
wherein the mitigating action comprises replacing the component with a healthy component, or reallocating or reconfiguring a healthy component near the component.
wherein the mitigating action comprising applying a particular airflow approximate the component to reduce the temperature level and the humidity level below the threshold level.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for based on the query, selecting a website; exemplary means for identifying a plurality of media on the website; exemplary means for based at least on the query, selecting a portion of the plurality of media on the website; exemplary means for extracting content from each of the selected portion of the plurality of media based on the query; exemplary means for generating semantic summaries of the extracted content; exemplary means for aggregating the semantic summaries into an aggregated semantic summary; and exemplary means for providing the aggregated semantic summary to the user.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for predicting a failure of a data center component based on environmental conditions, the system comprising:
a data center management system, the data center management system comprising a
processor;
a data center sensor;
a historical database comprising historical component state data, historical environment state data, component corrosion rates, and location data, the historical component state data comprising a metric that represents a health status or an attribute of components in data centers during a period of time prior to a component failure, the historical environment state data comprising a temperature and a humidity proximate the components in the data centers during the period of time prior to the component failure, the component corrosion rates providing a rate of corrosion of the components during the period of time prior to the component failure based at least on the environment data with respect to the component, and the location data comprising information on a location of the components;
a computer-readable medium comprising computer-executing instructions that, when executed by the processor, cause the processor to perform the following operations:
receiving, from the data center sensor, an indication that a current environmental condition of an environment proximate to a component in a data center exceeds an environment threshold level;
based at least on the indication, using the current environmental condition, the historical component state data, the historical environment state data, the component corrosion rates, and the location data to determine a corrosion rate for the component;
based at least on the corrosion rate for the component, determining a time the component will fail; and
in response to determining the time the component will fail, performing a mitigation action for the component prior to a failure of the component.

2. The system of claim 1, wherein the current environmental condition comprises a temperature level and a humidity level.

3. The system of claim 1, wherein the component is a solid state drive.

4. The system of claim 1, further comprising a component failure prediction platform coupled to the historical database, the component failure prediction platform generating a machine learning failure prediction algorithm that determines the time the component will fail.

5. The system of claim 1, wherein the mitigating action comprises migrating virtual machines hosted on the component to another component that has a risk of failure below a risk threshold.

6. The system of claim 1, wherein the mitigating action comprises replacing the component with a healthy component, or reallocating or reconfiguring the healthy component near the component.

7. The system of claim 1, wherein the mitigating action comprising applying a particular airflow approximate the component to reduce the temperature level and the humidity level below the environmental threshold level.

8. A computerized method comprising:
receiving an indication that a current environmental condition of an environment proximate to a component in a data center exceeds an environment threshold level;
based at least on the indication, determining, using the current environmental condition, a location of the component, and historical data of other components exposed to environmental conditions that exceed the environment threshold level, a corrosion rate for the component;
based at least on the corrosion rate for the component, determining a time the component will fail; and
in response to determining the time the component will fail, performing a mitigation action for the component prior to a failure of the component.

9. The computerized method of claim 8, wherein the historical data comprises historical component state data, historical environment state data, and component corrosion rates.

10. The computerized method of claim 8, wherein the current environmental condition comprises a temperature level and a humidity level.

11. The computerized method of claim 8, wherein the component is a solid state drive.

12. The computerized method of claim 11, wherein the mitigating action comprises migrating virtual machines hosted on the component to another component that has a risk of failure below a risk threshold.

13. The computerized method of claim 8, wherein the mitigating action comprises replacing the component with a healthy component, or reallocating or reconfiguring the healthy component near the component.

14. The computerized method of claim 8, wherein the mitigating action comprising applying a particular airflow approximate the component to reduce the temperature level and the humidity level below the environmental threshold level.

15. A computer storage medium storing computer-executable instructions that, upon execution by a processor, cause the processor to perform the following:
receive an indication that a current environmental condition of an environment proximate to a component in a data center exceeds an environment threshold level;
based at least on the indication, determine, using the current environmental condition, a location of the component, and historical data of other components exposed to environmental conditions that exceed the environment threshold level, a corrosion rate for the component;
based at least on the corrosion rate for the component, determine a time the component will fail; and
in response to determining the time the component will fail, perform a mitigation action for the component prior to a failure of the component.

16. The computer storage medium of claim 15, wherein the environmental condition comprises a temperature level and a humidity level.

17. The computer storage medium of claim 15, wherein the component is a solid state drive.

18. The computer storage medium of claim 18, wherein the computer-executable instructions, upon execution by the processor, further cause the processor to at least:
apply a machine learning failure prediction algorithm that determines the time the component will fail.

19. The computer storage medium of claim 15, wherein the mitigating action comprises migrating virtual machines hosted on the component to another component that has a risk of failure below a risk threshold.

20. The computer storage medium of claim 15, wherein the mitigating action comprises replacing the component with a healthy component, reallocating or reconfiguring the healthy component near the component, or applying a particular airflow approximate the component to reduce the temperature level and the humidity level below the environment threshold level
